(19) United States
(12) Patent Application Publication
(10) Pub. No.: US 2005/0036824 A1
(43) Pub. Date: Feb. 17, 2005

(54) Ring binder adapter for holding non-perforated sheet material

(76) Inventor: James W. Moss, Louisville, KY (US)

Correspondence Address: MIDDLETON & REUTLINGER, 2500 BROWN & WILLIAMSON TOWER, LOUISVILLE, KY, 40202, US

(21) Appl. No.: 10/641,230

(22) Filed: Aug. 14, 2003

(51) Int. Cl. B42F 3/00

(52) U.S. Cl. 402/8

(57) ABSTRACT

A sheet material holding device for receipt in a ring binder includes an elongated rectangular-shaped insert with a plurality of aligned apertures along one side. Each of the aligned apertures are positioned for registration with one of the rings of the binder. In each end of the insert is at least one slot wherein the slots are aligned to receive an endless elastomeric cord, or the like therein. A sheet of music or other sheet materials may be passed underneath the elastomeric cord and will be retained in place by the pressure of the elastomeric cord.

### BACKGROUND OF THE INVENTION

This invention relates to holding devices for sheet material and more particularly to a holding device for non-perforated sheet material which is adapted to be received by a ring binder.

It is common practice of presenters, teachers, members of choirs and choral groups to use a binder to hold assembled books, leaves, or sheets in the form of printed matter, for reference. Some of these materials, sheet music, for example, is generally purchased, sold and used in a non-perforated form in various dimensions and thickness; that is, not designed to be retained in a common three ring binder.

There are a variety of binders/folders produced and sold to accommodate such non-perforated books, leaf and sheet materials. These generally employ wires, or pliant, deformable means such as elastic cords, or rubber bands suspended between metal or plastic hooks, or connectors, situated at the top and bottom of the inner face of the spine of the binder/folder extending along the juncture of the leaf fold, cooperating with the leaf fold and continuous with the leaf fold.

Moreover, sheet music is commonly purchased or rented from a publisher or borrowed from an independent source in a non-perforated book, leaf or pamphlet form. And, the purchaser may not reproduce these materials. Furthermore, margin notes, important, for example, to musicians, are not permitted.

In many cases, a choral program for example, is performed requiring both perforated and non-perforated sheets. This produces complications for the music librarians.

### SUMMARY OF THE INVENTION

It is an object of the present invention to provide an adaptor that allows non-perforated books, leaves, pamphlets, folded single sheets, and other types of sheet material of various thickness to be retained in a ring binder.

It is another object of the present invention to provide an insert for a multi-ring binder making it possible to retain both punched and unpunched sheet material, including documents of various dimensions and thicknesses therein.

More particularly, the present invention is directed to a document holding device which includes an elongated rectangular-shaped insert for a ringed binder, usually a three-ring binder, which includes an appropriate number of registering apertures along one side for receipt by the rings of the binder. Each end of the elongated rectangular insert is provided with at least one slot, the slots in each end being in alignment. Each aligned slot receives an endless elastomeric cord or rubber band or the like therein wherein sheet materials, including documents, are received between the elastomeric cord and the insert, the elastomeric cord or rubber band holding the sheet materials intact.

Other objects and advantages of the present invention will become apparent upon the reading fo the detailed description of the preferred embodiment as described hereinafter.

### BRIEF DESCRIPTION OF THE DRAWINGS

A better understanding of the invention will be had upon reference to the following description in conjunction with the accompanying drawings in which like numerals refer to like parts throughout the several views and wherein:

FIG. 1 is a perspective view of one preferred binder insert of the present invention;

FIG. 2 is a perspective view of the insert of FIG. 1 with sheet material being placed therein; and,

FIG. 3 is a perspective view of the insert of FIG. 1 as received within a three-ring binder with sheet material in place therein.

### DETAILED DESCRIPTION OF THE PREFERRED EMBODIMENT

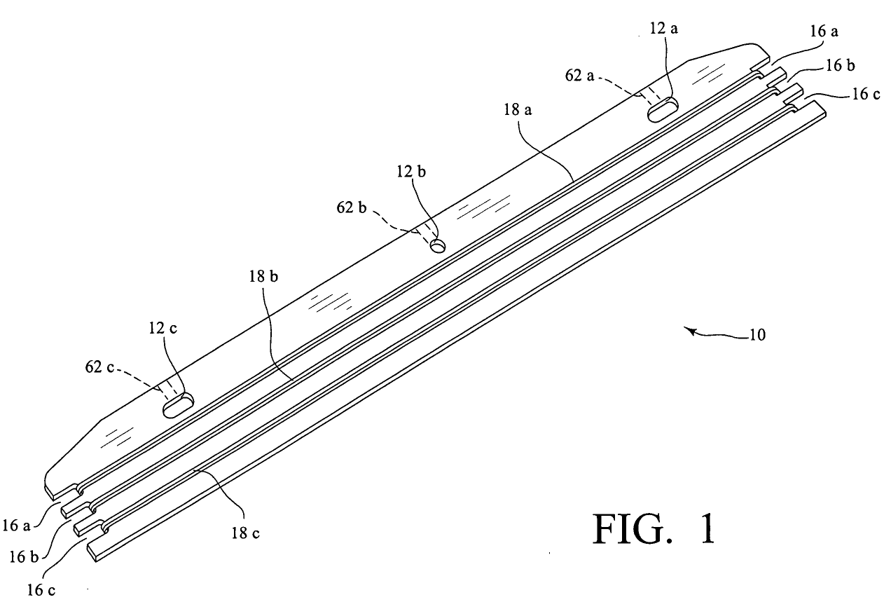

In FIG. 1 is shown a sheet material holding device 10 of the present invention. The holding device 10 is generally made from any type of relatively rigid material with a plurality of aligned apertures 12a, 12b and 12c aligned along one side. A preferred material is a plastic. The apertures 12a, 12b and 12c are registering apertures and are located to correspond to rings of a three-ring binder. Apertures 12a and 12c are shown as being of oval configuration whereas aperture 12b is shown as being of circular configuration. These are preferred configurations for the insert which allows easy insertion into a three-ring binder. However, it is realized that the apertures 12a, 12b and 12c may all be circles, may all be oval shaped or may be of other configurations as desired. Moreover, the apertures 12a, 12b and 12c may be of key-shaped design having a slot as indicated in phantom lines as 62a, 62b and 62c, for easy insertion into a three-ring binder without opening the rings.

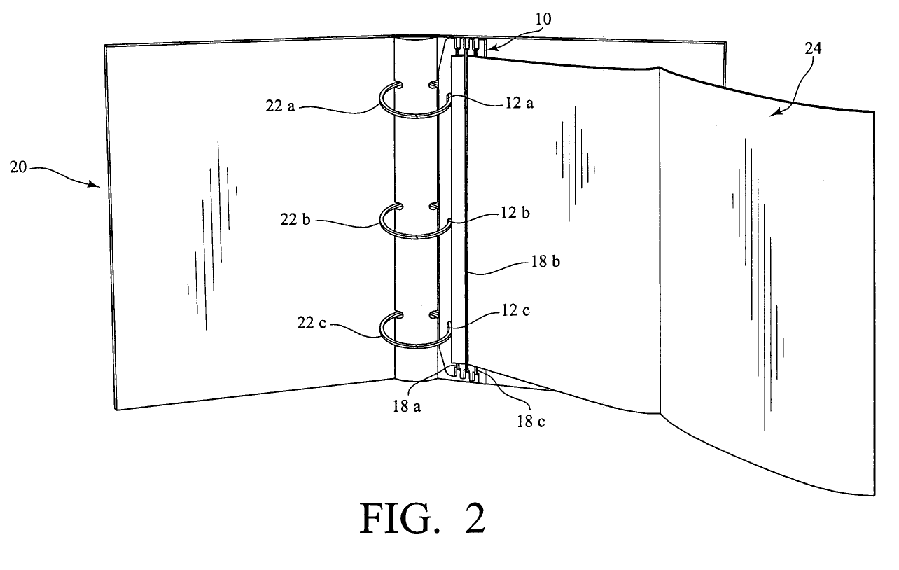

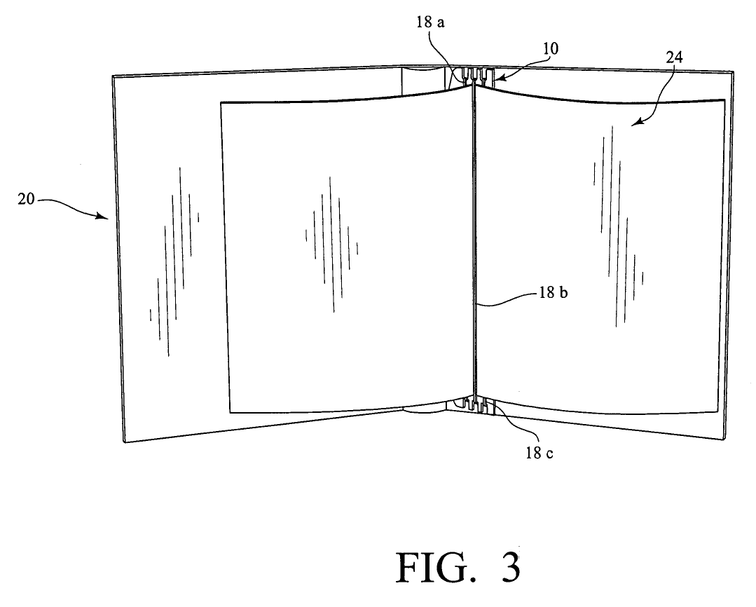

The opposed ends of the insert 10 are provided with aligned slots to receive an elastomeric cord, rubber band, or the like therein. As shown in FIG. 1, a plurality of slots 14a, 14b and 14c are along one end of the insert 10 and are in alignment with opposed slots 16a, 16b and 16c, respectively, in the opposed end of the insert 10. A plurality of endless elastomeric cords, such as, rubber bands 18a, 18b and 18c are received within the aligned slots for receipt therein of sheet material as shown in FIGS. 2 and 3. In FIG. 3 is shown an insert 10 placed within a three-ring binder 20. The three-ring binder is provided with snap rings 22a, 22b and 22c; snap rings 22a, 22b and 22c being in registration with the apertures 12a, 12b and 12c, respectively, of the insert 10.

As shown in FIG. 2, a document 24, such as a sheet music booklet 24, is being placed into the insert 10 which is received within a three ring binder 20. In placing the booklet 24 into the insert 10, the booklet 24 is opened to a leaf fold therein and then one elastomeric cord 18a, 18b or 18c is lifted and the pamphlet leaf is passed beneath the cord 18a, 18b or 18c to the leaf fold as shown in FIG. 3. The elastomeric cord, for example 18b, is then released which allows for the sheet material to be retained in place by the pressure of the plaint elastomeric cord. Other sheet material may be placed under the remaining cords 18a and 18c.

The detailed description is given primarily for clearness of understanding and no unnecessary limitations are to be understood therefrom for modifications will become obvious to those skilled in the art upon reading this disclosure and may be made without departing from the spirit of the invention and scope of the appended claims.

1. A sheet material holding device comprising:
an elongated rectangular-shaped binder insert including a plurality of apertures aligned alone one side of said insert;
At least one open-ended slot in each end of said insert, said slots being aligned to receive and an endless elastomeric cord therein.

2. The holding device of claim 1 wherein said insert is a rigid strip of plastic.

3. The holding device of claim 1, said plurality of aligned apertures being three apertures positioned to align with registering rings of a three-ring binder.

4. The holding device of claim 1 including an endless elastomeric cord received with said slots of said insert.

5. The holding device of claim 3 wherein the apertures at opposed ends of said insert are of oval configuration.

6. The holding device of claim 1 including a narrowed slot extending from each aperture to and is open at said one said side.
